(19) United States
(12) Patent Application Publication
(10) Pub. No.: US 2006/0093251 A1
(43) Pub. Date: May 4, 2006

(54) Bearing assembly

(75) Inventors: Marlon R. Casey, Indianapolis, IN (US); Aaron H. Kunkle, Indianapolis, IN (US)

Correspondence Address: QUARLES & BRADY LLP, 411 E. WISCONSIN AVENUE, SUITE 2040, MILWAUKEE, WI, 53202-4497, US

(73) Assignee: Rexnord Industries, Inc.

(21) Appl. No.: 10/977,080

(22) Filed: Oct. 29, 2004

(51) Int. Cl. F16C 43/00

(52) U.S. Cl. 384/538

(57) ABSTRACT

The bearing assembly includes a split cylindrical adapter sleeve for wrapping around a shaft. An inner ring encircling the adapter sleeve engages the adapter sleeve. In one embodiment of the present invention, a split lock nut encircling the adapter sleeve defines an axial gap and has a radially inwardly facing surface including threads threadably engaging the threads formed on the sleeve. A tightening fastener operatively engaging the lock nut across the gap tightens the lock nut onto the adapter sleeve. In another embodiment of the present invention, a compressible member is interposed between the lock nut and the inner ring. The compressible member is compressible a predetermined amount to indicate that the bearing assembly is properly clamped onto the shaft.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The field of invention is bearings, and more particularly, to a shaft mounted wedge-type bearing assembly.

It is generally known to mount bearing assemblies on a shaft through the use of set screws or eccentric collars which lock the inner ring of the bearing assembly to the shaft. In such designs, the inner ring of the bearing assembly extends longitudinally along the shaft and is incorporated in the mechanisms for sealing the inner ring against the shaft and for locking the bearing assembly on the shaft.

It is also known to provide a bearing assembly with an inner ring which has extending therethrough a tapered bore and which loosely surrounds the shaft. Such bearing assembly designs also include a cylindrical wedge or tapered mounting adapter sleeve that is also placed over the shaft. The sleeve has therein a longitudinally extending slit which allows the sleeve to be placed over the shaft but affords compression or squeezing the sleeve into frictional engagement with the shaft. The sleeve is urged into engagement with the tapered bore in the inner ring of the bearing assembly by a lock nut. The wedge-like engagement between the tapered sleeve and the tapered bore creates an interference fit between the sleeve and the inner ring, and compresses the sleeve into locked engagement with the shaft. The locked engagement between the inner ring and the sleeve, and between the sleeve and the shaft thereby fixes the inner ring relative to the shaft.

The use of a tapered sleeve in conjunction with a tapered inner ring to mount a bearing assembly on a shaft is advantageous in that this type of bearing assembly mounting accommodates shafts which may have a circumference differing from a nominal specified circumference. However, if the lock nut is not properly tightened, such that the adapter sleeve is properly tightened onto the shaft, the bearing assembly can be damaged or the lock nut will loosen over time. Moreover, even if the lock nut is tightened properly initially, the lock nut often loosens over time and require periodic tightening. Therefore, a need exists for a shaft mounted wedge-type bearing assembly that is easily properly tightened onto the shaft and/or includes a lock nut that does not loosen over time.

### BRIEF SUMMARY OF THE INVENTION

The present invention provides a bearing assembly that includes a lock nut that does not loosen over time and/or has an indicator that shows a user when the lock nut is properly tightened. The bearing assembly includes a split cylindrical adapter sleeve for wrapping around a shaft. The sleeve has a radially outwardly facing surface including a threaded section proximal one axial end of the sleeve and a tapered section extending from the threaded section toward an opposing axial end of the sleeve. The tapered section has a first diameter which is greater than a second diameter, and the threaded section including threads. An inner ring encircling the adapter sleeve and having a radially inwardly facing surface between axial ends of the inner ring engages the tapered section of the adapter sleeve.

In one embodiment of the present invention, a split lock nut encircling the adapter sleeve defines an axial gap and has a radially inwardly facing surface including threads threadably engaging the threads formed on the radially outwardly facing surface of the sleeve, wherein rotation of the lock nut in one direction of rotation urges the inner ring over the adapter sleeve to compress the adapter sleeve and fix the inner bearing ring relative to the shaft. A tightening fastener operatively engaging the lock nut across the gap has a loose position and a tightening position. In the loose position, the lock nut is rotatable in the one direction. In the tightening position, the tightening fastener narrows the gap to tighten the lock nut onto the sleeve and inhibit rotation of the lock nut.

In another embodiment of the present invention, a compressible member is interposed between the lock nut and the inner ring. The compressible member is compressible a predetermined amount to indicate that the bearing assembly is properly clamped onto the shaft.

A general objective of the present application is to provide a shaft mounted bearing assembly having a lock nut that is not easily loosened over time. This objective is accomplished by providing a lock nut including a tightening fastener that tightens the lock nut onto the adapter sleeve.

Another objective of the present invention is to provide a bearing assembly that has an indicator showing a user when the adapter sleeve is properly tightened onto the shaft. This objective is accomplished by providing a compressible member interposed between the lock nut and the inner ring that is compressible a predetermined amount to indicate that the bearing assembly is properly clamped onto the shaft.

The foregoing and other objectives and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a cut away elevation view of a shaft mounted bearing assembly incorporating the present invention;

FIG. 2 is a detailed view of the cut away section of FIG. 1;

FIG. 3 is a sectional view along line 3-3 of FIG. 1;

FIG. 4 is a end view of the lock nut of FIG. 1;

FIG. 5 is a detailed view along line 5-5 of FIG. 4;

FIG. 6 is a detailed view along line 6-6 of FIG. 2;

FIG. 7 is an alternative lock nut incorporating the present invention; and

FIG. 8 is another alternative lock nut incorporating the present invention.

### DETAILED DESCRIPTION OF THE PREFERRED EMBODIMENTS

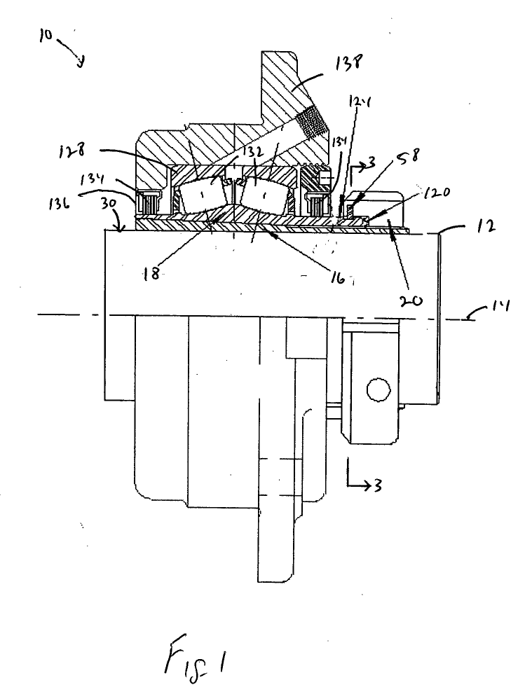

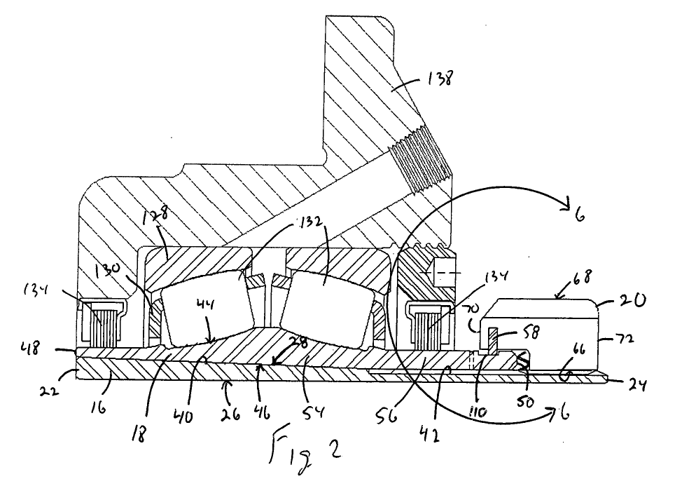

As shown in FIGS. 1-3, a wedge-type bearing assembly 10 is mounted on a shaft 12 having a longitudinal axis 14. The bearing assembly 10 includes an adapter sleeve 16 frictionally engaging the shaft 12, an inner ring 18 compressing the adapter sleeve 16 against the shaft 12, and a lock nut 20 axially fixed relative to the inner ring 18 and threadably engaging the adapter sleeve 16. Rotation of the lock nut 20 in a first direction of rotation urges the inner ring 18 over the adapter sleeve 16 to mount the bearing assembly 10 to the shaft 12. Rotation of the lock nut 20 in a second opposite direction of rotation urges the inner ring 18 off of the adapter sleeve 16 to dismount the bearing assembly 10 from the shaft 12.

The cylindrical adapter sleeve 16 extends along the axis 14 of the shaft 12 between adapter sleeve first and second ends 22, 24, and has a radially inwardly facing surface 26 and a radially outwardly facing surface 28. The radially inwardly facing surface 26 defines a uniform cylindrical bore which engages the outer surface 30 of the shaft 12. A longitudinal slit 32 having slit edges 34, 36 extends the entire axial length of the sleeve 16. The slit edges 34, 36 define a gap 38 therebetween when the sleeve 16 is undeformed (i.e. not compressed by the inner ring 18) which is narrowed as the adapter sleeve 16 is radially compressed by the inner ring 18. The sleeve 16 is sized to slide over the shaft 12 when the sleeve 16 is undeformed, and the provision of the slit 32 along the sleeve 16 affords compression of the sleeve 16 into locked frictional engagement with the shaft 12 in a manner discussed below.

The radially outwardly facing surface 28 of the sleeve 16 includes a tapered section 40 engageable with the inner ring 18 and a threaded section 42 extending axially from the tapered section 40. The tapered section 40 extends from the first end 22 of the sleeve 16 toward the second, opposite end 24 of the sleeve 16, and is frustoconical with a first relatively large diameter proximal the first end 22 of the sleeve 16. The diameter of the tapered section 40 uniformly decreases toward the sleeve second end 24. Various angles of taper, such as between about 3° to 4°, can be used.

The threaded section 42 extends axially from the tapered section 40 to the second end 24 of the sleeve 16. External threads 52 formed in the threaded section 42 threadably engage internal threads 60 formed in the lock nut 20. The threaded section 42 is shown to extend from the tapered section 40 to the second end 24 of the sleeve 16, however, the threaded section 42 can extend from the tapered section 40 to the first end 22 of the sleeve 16 without departing from the scope of the invention.

The inner ring 18 of the bearing assembly 10 is configured to mate with the sleeve 16 so that the bearing assembly 10 can be fixed to the shaft 12. The generally annular inner ring 18 surrounds the shaft 12, and has an axis substantially coaxial with the shaft axis 14. The inner ring 18 includes a radially outwardly facing surface 44 and a radially inwardly facing surface 46 joined by axially opposing inner ring first and second ends 48, 50. The radially outwardly facing surface 44 provides a bearing surface for rollers 132.

The radially inwardly facing surface 46 of the inner ring 18 includes a tapered section 54 and an engagement section 56. The tapered section 54 overlies the tapered section 40 of the adapter sleeve 16 and has a first diameter at the first axial end 48 of the inner ring 18 and a second diameter proximal the second axial end 50. The first diameter is larger than the second diameter to form a tapered bore extending through the inner ring 18 from the first axial end 48 toward the second axial end 50 of the inner ring 18. Preferably, the tapered section 54 of the inner ring 18 lies at an angle relative to the axis 14 which approximates the angle of the tapered section 40 of the sleeve 16. When the inner ring 18 is urged over the adapter sleeve 16, the tapered section 40 of the sleeve 16 slides along and engages the tapered section 54 of the radially inwardly facing surface 46 of the inner ring 18 to compress the adapter sleeve 16 against the shaft 12.

The engagement section 56 of the radially inwardly facing surface 46 of the inner ring 18 extends from the tapered section 54 of the inner ring 18 to the second axial end 50 of the inner ring 18. A radially outwardly opening circumferential groove 110 formed in the engagement section 56 proximal the second end 24 of the adapter sleeve 16 slidably engages radially extending locking members 58 to axially lock the lock nut 20 relative to the inner ring 18 while allowing the lock nut 20 to rotate relative to the adapter sleeve 16 and inner ring 18.

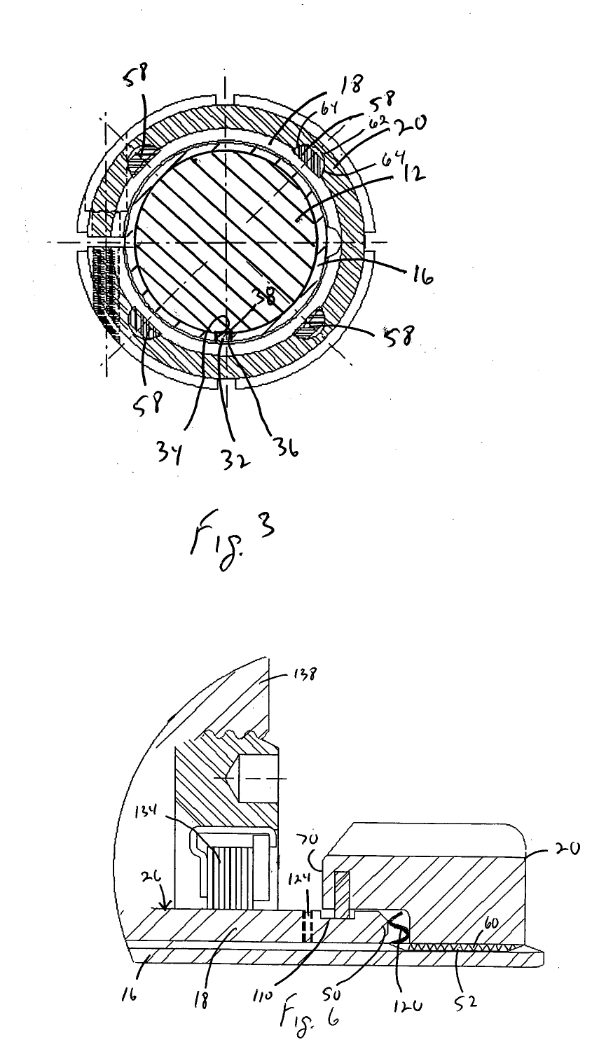

The cylindrical lock nut 20 shown in FIGS. 1-4 threadably engages the adapter sleeve 16 and is axially fixed relative to the inner ring 18 by the locking members 58 to move the inner ring 18 relative to the adapter sleeve 16 in either axial direction. The lock nut 20 includes a radially inwardly facing surface 66 and a radially outwardly facing surface 68, both of which extend between first and second lock nut ends 70, 72. Although axially fixing the lock nut 20 relative to the inner ring 18 is preferred, axially fixing the lock nut 20 relative to the inner ring 18 is not required to practice the invention. Moreover, an inwardly opening circumferential groove can be formed in the radially inwardly facing surface 66 of the lock nut 20 for slidably receiving locking members extending from the inner ring 18 to axially fix the lock nut 20 and inner ring 18 relative to each other without departing from the scope of the invention.

The radially inwardly facing surface 66 of the lock nut 20 includes the internal threads 60 and radially inwardly opening circumferentially spaced slots 80 facing the radially outwardly opening groove 110 of the inner ring 18. Each slot 80 includes a curved bottom surface 62 that engages the locking member 58 received therein. The internal threads 60 are formed in the radially outwardly facing surface 68 proximal the lock nut first end 70, and threadably engage the external threads 52 formed in the adapter sleeve 16.

Each locking member 58 is received in one of the slots 80 and extends into the radially outwardly opening circumferential groove 110 formed in the engagement section 56 of the adapter sleeve 16 to axially lock the lock nut 20 relative to the inner ring 18 while allowing the lock nut 20 to rotate relative to the adapter sleeve 16 and inner ring 18. Preferably, each locking member 58 is a woodruff key having surfaces 64 that conform to the curved bottom surface 62 of the slot 80 receiving the locking member 58. Although Woodruff keys are preferred, any locking members known in the art for axially fixing the lock nut 20 relative to the inner ring 18 can be used, such as set screws, snap rings, lips extending from the lock nut or inner ring, pins, rectangular keys, and the like, without departing from the scope of the invention.

The radially outwardly facing surface 68 of the lock nut 20 includes notches 74 engageable with a wrench to rotate the lock nut 20 relative to the inner ring 18 and adapter sleeve 16. Rotation of the lock nut 20 threadably engages the external threads 52 formed in the adapter sleeve 16 with the internal threads 60 of the lock nut 20 to axially move the inner ring 18 relative to the adapter sleeve 16 in either axial direction. Although diametrically opposed notches 74 for engaging a wrench are shown, any structure forming part of the lock nut 20 engageable with a tool, such as a wrench, for rotating the lock nut 20 can be used, such as flats, teeth, and the like, without departing from the scope of the invention.

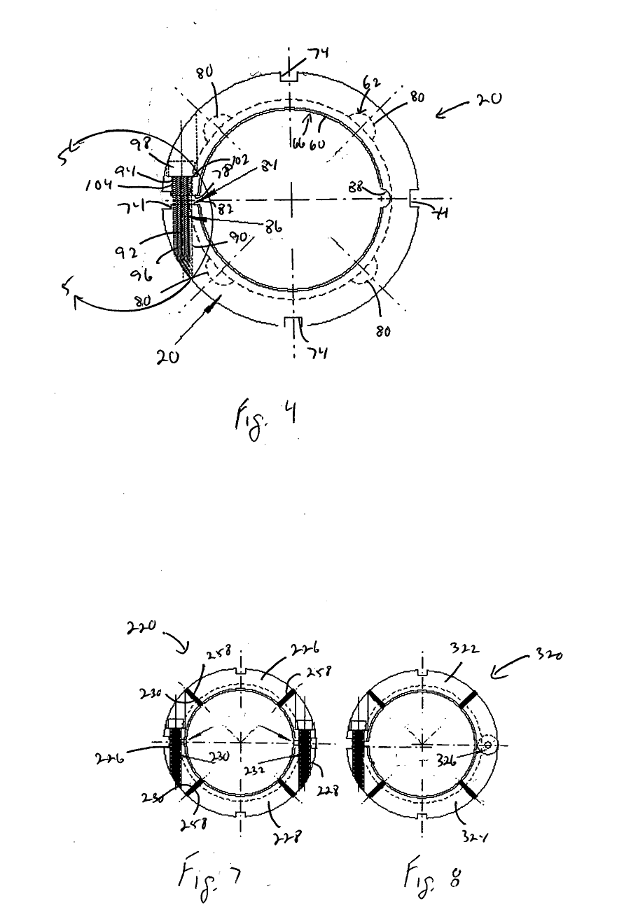

Preferably, the lock nut 20 is split which allows the nut to be tightened against the adapter sleeve 16 once the bearing assembly 10 is clamped onto the shaft 12. As shown in FIG. 5, a longitudinal slit 76 having slit edges 78, 82 extends the entire axial length of the lock nut 20. The slit edges 78, 82 define a gap 84 therebetween when the lock nut 20 is loose (i.e. not tightened against the adapter sleeve 16). An axially extending notch 88 having a semicircular cross section formed in the radially inwardly facing surface 66 of the lock nut 20 diametrically opposed to the gap 84 provides stress relief for the lock nut 20 as the gap 84 is narrowed.

The gap 84 is narrowed to radially tighten the lock nut 20 against the adapter sleeve 16 by a lock bolt 86 operatively engaging the lock nut 20. The lock bolt 86 received in a tangential bolt hole 90 bridging the gap 84 includes an elongated threaded body 92 having a proximal end 94 and a distal end 96. A head 98 formed at the distal end 96 engages a step 102 formed in an unthreaded portion 104 of the bolt hole 90 on one side of the gap 84 to prevent the head 98 from passing completely through the bolt hole 90. The lock bolt body 92 extends across the gap 84 and includes external threads 106 that threadably engage internal threads 108 formed in a threaded portion 112 of the bolt hole 90 on the other side of the gap 84.

Rotation of the lock bolt 86 in one direction engages the external threads 106 of the lock bolt 86 with the internal threads 108 of the bolt hole 90 and moves the lock bolt from a loose position to a tightening position. In the loose position, the lock nut 20 is rotatable to threadably engage the threads 106, 108 and move the lock nut 20 axially. In the tightening position, the lock bolt 86 narrows the gap 84 and tightens the lock nut 20 (i.e. reduce the thread diameter of the lock nut 20, such that an interference fit is achieved between the lock nut internal threads 60 and the adapter sleeve external threads 52) onto the adapter sleeve 16. Advantageously, tightening the lock nut 20 onto the adapter sleeve 16 creates a radial hydrostatic clamping force from the lock nut 20 into the adapter sleeve 16 which positively locks the lock nut 20 relative to the adapter sleeve 16 and further compresses the adapter sleeve 16 onto the shaft 12 to keep the bearing assembly 10 from loosening. Although a lock bolt 86 that tightens the lock nut 20 onto the adapter sleeve 16 is preferred, any tightening fastener, such as the lock bolt 86, an axial cam, an over center clasp, a hose clamp, and the like, can be used without departing from the scope of the invention.

As shown in FIG. 6, proper tightening of the bearing assembly 10 onto the shaft 12 is easily determined by a compressible member interposed between the lock nut 20 and the inner ring 18. The axially compressible member 120, such as a wave spring, a Belleville washer, a curved washer, a rubber washer, plastic washer, and the like, is axially compressed between the lock nut 20 and inner ring 18 a predetermined amount when the bearing assembly 10 is properly clamped onto the shaft 12.

The particular compressible member 120 having a known spring constant is selected dependent upon the desired clamping force desired for clamping the bearing assembly 10 onto the shaft 12 and the desired amount of compression of the compressible member 120. For example, in one application a wave spring may be used for a desired compression of 0.010 inches under an axial force of 500 pounds. In other applications, more or less compression may be desired under more or less axial force.

In the embodiment disclosed herein, the compressible member 120 is a single wave spring encircling the adapter sleeve 16, however, the compressible member 120 can include multiple members having any shape to achieve the desired compression characteristics for the desired application. For example, the compressible member can be one or more plugs interposed between the lock nut and inner ring without departing from the scope of the invention. Of course, the plugs can be received in axial holes formed in one of the lock nut and inner ring to maintain the plugs in position as the bearing assembly is mounted onto the shaft.

An indicator groove 124, or other marking, on the inner ring radially outwardly facing surface 44 aligns with the first end 70 of the lock nut 20 when the compressible member 120 is compressed the predetermined amount to indicate that the desired axial force is acting on the compressible member 120 and that the bearing assembly 10 is properly clamped onto the shaft 12. Advantageously, aligning the indicator groove 124 with the first end 70 of the lock nut 20 provides an easily visible indication that the compressible member 120 is compressed the predetermined amount. Although aligning the indicator groove 124 with the first end 70 of the lock nut is shown, the indicator groove 124 can be positioned on the inner ring 18 to register, i.e. properly align, with any portion of the lock nut 20 without depart from the scope of the invention.

Referring now to FIGS. 1-4, the bearing assembly 10 further includes an outer ring 128 radially spaced from the inner ring 18 to sandwich a plurality of rollers 132 therebetween. The rollers 132 allow the rings 18, 128 to move relative to each other. The term “roller” used herein can be any roller used in the art, such as ball bearings, cylindrical rollers, tapered rollers, and the like, that allow relative movement of the inner and outer rings 18, 128. A retainer ring 130 can be provided to space the rollers 132 between the inner and outer rings 18, 128.

Seal rings 134 extending between the inner and outer rings 18, 128 on opposing sides of the rollers 132 seal lubricant around the rollers 132. Seal guards fixed to the inner ring 18 and covering the seal rings 134 can be provided to protect the seal rings 134 from contamination. A housing 138 can also be provided that surrounds the inner ring 18 and rollers 132 and is fixed relative to the outer ring 128 without departing from the scope of the invention.

In use, the bearing assembly 10 is mounted on the shaft 12 by slipping the adapter sleeve 16 onto the shaft 12. The inner ring 18, along with the rollers 132 and outer ring 128 are then slipped axially onto the shaft 12 over the adapter sleeve 16. The compressible member 120 is slipped onto the adapter sleeve 16 abutting the inner ring second end 50. The locking members 58 are then inserted into the slots 80 formed in the lock nut 20, and the lock nut 20 is wrapped around the adapter sleeve 16 and inner ring 18 with the locking members 58 received in the circumferential groove 110 formed in the inner ring 18 to axially lock the lock nut 20 relative to the inner ring 18 with the compressible member 120 interposed between the lock nut 20 and inner ring 18.

The lock nut 20 is then rotated in a first direction to urge the inner ring 18 further over the adapter sleeve 16. As the tapered section 40 of the adapter sleeve 16 and the tapered bore of the inner ring 18 become wedged together, the sleeve 16 compresses and the gap 38 defined by the slit edges 34, 36 narrow. Rotation of the lock nut 20 is stopped when the compressible member 120 is sufficiently compressed, such that the first end 70 of the lock nut 20 aligns with the indicator groove 124 formed on the inner ring 18 to indicate that the bearing assembly 10 is properly clamped onto the shaft 12.

Once the bearing assembly 10 is properly tightened onto the shaft 12 as indicated by the desired compression of the compressible member 120, the lock nut 20 is radially tightened onto the adapter sleeve 16 by rotating the lock bolt 86. Rotating the lock bolt 86 to move the lock bolt 86 from the loose position to the tightening position narrows the gap 84 in the lock nut 20 and tightens the lock nut 20 onto the adapter sleeve 16 to prevent the lock nut 20 from loosening over time.

The bearing assembly 10 is dismounted from the shaft 12 by moving the lock bolt 86 from the tightening position to the loose position and then rotating the lock nut 20 in the second direction opposite to the first direction of rotation. Rotating the lock nut 20 in the second direction urges the inner ring 18 axially off of the adapter sleeve 16 to unwedge the tapered section 40 of the adapter sleeve 16 and the tapered bore of the inner ring 18. As the inner ring 18 is urged axially off of the adapter sleeve 16, the adapter sleeve 16 expands to release its grip on the shaft 12.

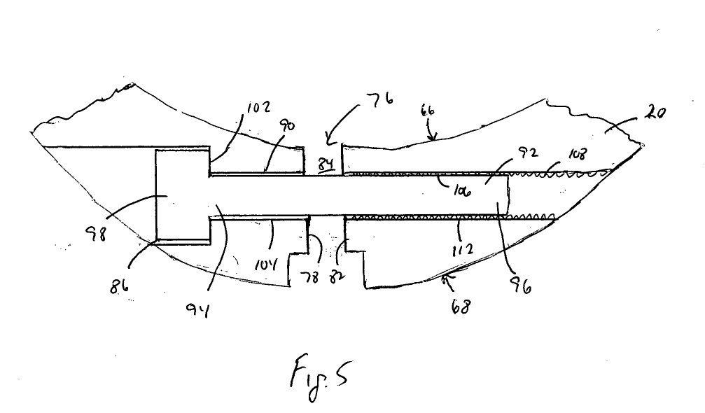

In an alternative construction shown in FIG. 7, the lock nut 220 is formed from two semicircular members 222, 224. A pair of lock bolts 226, 228 extending through lock bolt holes 230, 232 formed through each semicircular member 222, 224 join the semicircular members 222, 224 together to form the lock nut 220 and tighten the lock nut onto the adapter sleeve 16 shown in FIG. 1. Locking members 258 in the form of set screws, or pins, enter through radially extending holes 230 formed through the lock nut 220 and are received in the circumferential groove 110 formed in the inner ring 18 of the first embodiment shown in FIG. 1.

In another alternative construction shown in FIG. 8, the lock nut 320 is formed from two semicircular members 322, 324 joined by a hinge 326. A lock bolt 328 extending through a tangential bolt hole 330 formed through the semicircular members 322, 324 is tightened to clamp the lock nut 320 onto the adapter sleeve 16 shown in FIG. 1.

While there have been shown and described what is at present considered the preferred embodiments of the invention, it will be obvious to those skilled in the art that various changes and modifications can be made therein without departing from the scope of the invention defined by the appended claims.

We claim:

1. A bearing assembly comprising:
a split cylindrical adapter sleeve for wrapping around a shaft, said sleeve having a radially outwardly facing surface including a threaded section proximal one axial end of said sleeve and a tapered section extending from said threaded section toward an opposing axial end of said sleeve, said tapered section having a first diameter which is greater than a second diameter, and said threaded section including threads;
an inner ring encircling said adapter sleeve and having a radially inwardly facing surface between axial ends of said inner ring engaging said tapered section of said adapter sleeve;
a split lock nut encircling the adapter sleeve defining an axial gap and having a radially inwardly facing surface including threads threadably engaging said threads formed on said radially outwardly facing surface of said sleeve, wherein rotation of said lock nut in one direction of rotation urges said inner ring over said adapter sleeve to compress said adapter sleeve and fix said inner bearing ring relative to the shaft; and
a tightening fastener operatively engaging said lock nut across said gap, said tightening fastener having a loose position and a tightening position, wherein in said loose position, said lock nut is rotatable in said one direction, and in said tightening position, said tightening fastener narrows said gap to tighten said lock nut onto said sleeve and inhibit rotation of said lock nut.

2. The bearing assembly, as in claim 1, in which said lock nut is formed from at least two pieces joined together.

3. The bearing assembly, as in claim 1, in which said tightening fastener is a lock bolt.

4. The bearing assembly as in claim 1, in which said inner ring is axially fixed relative to said lock nut.

5. The bearing assembly as in claim 4, in which one of said inner ring and said lock nut includes a circumferential groove opening radially toward the other of said inner ring and said lock nut, and locking structure slidably received in said groove and axially fixes said inner ring relative to said lock nut.

6. The bearing assembly as in claim 5, in which said locking structure is selected from a group consisting of a key, a snap ring, a pin, a set screw, and a lip extending from the other of said inner ring and said lock nut.

7. The bearing assembly as in claim 1, in which a compressible member is interposed between said lock nut and said inner ring, said compressible member being compressible a predetermined amount to indicate that the bearing assembly is properly clamped onto the shaft.

8. The bearing assembly as in claim 8, in which a marking on said inner ring registers with said lock nut when said compressible member is compressed by said lock nut a predetermined amount.

9. The bearing assembly as in claim 8, in which said compressible member is a washer encircling said adapter.

10. The bearing assembly as in claim 8, in which said compressible member is selected from a group consisting of a wave spring, a Belleville washer, a curved washer, a rubber washer, a plastic washer, and a compressible plug.

11. A bearing assembly comprising:
a split cylindrical adapter sleeve for wrapping around a shaft, said sleeve having a radially outwardly facing surface including a threaded section proximal one axial end of said sleeve and a tapered section extending from said threaded section toward an opposing axial end of said sleeve, said tapered section having a first diameter which is greater than a second diameter, and said threaded section including threads;
an inner ring encircling said adapter sleeve and having a radially inwardly facing surface between axial ends of said inner ring engaging said tapered section of said adapter sleeve;
a lock nut encircling the adapter sleeve and having a radially inwardly facing surface including threads threadably engaging said threads formed on said radially outwardly facing surface of said sleeve, wherein rotation of said lock nut in one direction of rotation urges said inner ring over said adapter sleeve to compress said adapter sleeve and fix said inner bearing ring relative to the shaft; and
a compressible member interposed between said lock nut and said inner ring, said compressible member being compressible a predetermined amount to indicate that the bearing assembly is properly clamped onto the shaft.

12. The bearing assembly as in claim 11, in which said lock nut is a split lock nut defining an axial gap, and further including a tightening fastener operatively engaging said lock nut across said gap, said tightening fastener having a loose position and a tightening position, wherein in said loose position, said lock nut is rotatable in said one direction, and in said tightening position, said tightening fastener narrows said gap to tighten said lock nut onto said sleeve and inhibit rotation of said lock nut.

13. The bearing assembly, as in claim 12, in which said lock nut is formed from at least two pieces joined together.

14. The bearing assembly, as in claim 12, in which said tightening fastener is a lock bolt.

15. The bearing assembly as in claim 12, in which said inner ring is axially fixed relative to said lock nut.

16. The bearing assembly as in claim 15, in which one of said inner ring and said lock nut includes a circumferential groove opening radially toward the other of said inner ring and said lock nut, and locking structure slidably received in said groove and axially fixes said inner ring relative to said lock nut.

17. The bearing assembly as in claim 16, in which said locking structure is selected from a group consisting of a key, a snap ring, a pin, a set screw, and a lip extending from the other of said inner ring and said lock nut.

18. The bearing assembly as in claim 11, in which a marking on said inner ring registers with said lock nut when said compressible member is compressed by said lock nut a predetermined amount.

19. The bearing assembly as in claim 11, in which said compressible member is a washer encircling said adapter.

20. The bearing assembly as in claim 11, in which said compressible member is selected from a group consisting of a wave spring, a Belleville washer, a curved washer, a rubber washer, a plastic washer, and a compressible plug.

21. A bearing assembly comprising:
a split cylindrical adapter sleeve for wrapping around a shaft, said sleeve having a radially outwardly facing surface including a threaded section proximal one axial end of said sleeve and a tapered section extending from said threaded section toward an opposing axial end of said sleeve, said tapered section having a first diameter which is greater than a second diameter, and said threaded section including threads;
an inner ring encircling said adapter sleeve and having a radially inwardly facing surface between axial ends of said inner ring engaging said tapered section of said adapter sleeve;
a split lock nut encircling the adapter sleeve defining an axial gap and having a radially inwardly facing surface including threads threadably engaging said threads formed on said radially outwardly facing surface of said sleeve, wherein rotation of said lock nut in one direction of rotation urges said inner ring over said adapter sleeve to compress said adapter sleeve and fix said inner bearing ring relative to the shaft; and
a tightening fastener operatively engaging said lock nut across said gap, said tightening fastener having a loose position and a tightening position, wherein in said loose position, said lock nut is rotatable in said one direction, and in said tightening position, said tightening fastener narrows said gap to tighten said lock nut onto said sleeve and inhibit rotation of said lock nut; and
a compressible member interposed between said lock nut and said inner ring, said compressible member being compressible a predetermined amount to indicate that the bearing assembly is properly clamped onto the shaft.

22. The bearing assembly, as in claim 21, in which said lock nut is formed from at least two pieces joined together.

23. The bearing assembly, as in claim 21, in which said tightening fastener is a lock bolt.

24. The bearing assembly as in claim 21, in which said inner ring is axially fixed relative to said lock nut.

25. The bearing assembly as in claim 24, in which one of said inner ring and said lock nut includes a circumferential groove opening radially toward the other of said inner ring and said lock nut, and locking structure slidably received in said groove and axially fixes said inner ring relative to said lock nut.

26. The bearing assembly as in claim 25, in which said locking structure is selected from a group consisting of a key, a snap ring, a pin, a set screw, and a lip extending from the other of said inner ring and said lock nut.

27. The bearing assembly as in claim 21, in which a marking on said inner ring registers with said lock nut when said compressible member is compressed by said lock nut a predetermined amount.

28. The bearing assembly as in claim 21, in which said compressible member is a washer encircling said adapter.

29. The bearing assembly as in claim 21, in which said compressible member is selected from a group consisting of a wave spring, a Belleville washer, a curved washer, a rubber washer, a plastic washer, and a compressible plug.
